(19) United States
(12) Patent Application Publication
(10) Pub. No.: US 2026/0217019 A1
(43) Pub. Date: Jul. 30, 2026

(54) CONTROLLING A PRINTING PROCESS

(71) Applicant: LANDA CORPORATION LTD., Rehovot (IL)

(72) Inventors: Vitaly BURKATOVSKY, Rishon Lezion (IL); Ilya MUCHNIK, Rehovot (IL); Omer VULICH, Yehud (IL)

(21) Appl. No.: 19/147,702

(22) PCT Filed: Dec. 28, 2023
(86) PCT No.: PCT/IB2023/063306

§ 371 Date: Jul. 13, 2025

Related U.S. Application Data
(60) Provisional application No. 63/439,121, filed on Jan. 15, 2023.

(51) Int. Cl. B41J 2/005; B41J 11/00

(52) U.S. Cl. CPC B41J 2/0057; B41J 11/0095

(57) ABSTRACT

A printing system (10, 11) includes (i) an intermediate transfer member (ITM) (44), which is configured to receive ink droplets from an ink supply subsystem to form an ink image thereon, and to absorb at least part of an optical radiation (81) directed to the ITM (44) for heating the ITM (44), and (ii) an optical assembly (33) having one or more sensors (25), which are facing the ITM (44), and in response to sensing an optical signal emitted from at least one of the ITM (44) and a substance being carried by the ITM (44), the optical assembly (33) is configured to produce a signal indicative of the substance.

### CROSS-REFERENCE TO RELATED APPLICATIONS

This application claims the benefit of U.S. Provisional Patent Application 63/439,121, filed Jan. 15, 2023, whose disclosure is incorporated herein by reference.

### FIELD OF THE INVENTION

The present invention relates generally to printing systems, and particularly to methods and systems for detecting substance being carried by an intermediate transfer member of a printing system.

### BACKGROUND OF THE INVENTION

Some printing systems may have an intermediate transfer member on which an image is formed, and transfers the image to a target substrate, such as a sheet of paper. Sometimes, during the system operation, a substance, such as but not limited to at least a portion of the target substrate, may be sticked to and/or carried by the intermediate transfer member, and thereby may interfere with the operation of the printing system (e.g., a printing process) and/or may cause damage to one or more components of the printing system.

### SUMMARY OF THE INVENTION

An embodiment of the present invention that is described herein provides a printing system, including (i) an intermediate transfer member (ITM), which is configured to receive ink droplets from an ink supply subsystem to form an ink image thereon, and to absorb at least part of an optical radiation directed to the ITM for heating the ITM, and (ii) an optical assembly having one or more sensors, which are facing the ITM, and in response to sensing an optical signal emitted from at least one of the ITM and a substance being carried by the ITM, the optical assembly is configured to produce a signal indicative of the substance.

In some embodiments, the system includes a processor, which is configured to control an operation of the printing system responsively receiving the signal. In other embodiments, the ITM is configured to transfer the ink image to a target substrate, the substance includes at least a portion of the target substrate that remains on the ITM after the image has been transferred to the target substrate, and the signal is indicative of the at least portion of the target substrate that remains on the ITM. In yet other embodiments, the optical assembly includes one or more light sources, which are facing the ITM and are configured to direct the optical radiation to a surface of the ITM.

In some embodiments, at least one of the light sources includes an infrared (IR) light source, the optical radiation includes one or more IR beams, and the optical signal includes an IR radiation, and at least one of the sensors is configured to sense the IR radiation emitted from at least one of the ITM and the substance responsively to directing the one or more IR beams. In other embodiments, a beam axis of at least one of the light beams is perpendicular to a surface of the ITM. In yet other embodiments, in response to directing the one or more IR beams: (i) when facing the substance being carried by the ITM, at least a sensor among the sensors is configured to produce a first signal indicative of a first portion of the sensed IR radiation, and (ii) when facing the ITM, the sensor is configured to produce a second signal indicative of a second portion of the sensed IR radiation.

In some embodiments, the optical assembly include at least first and second sensing assemblies, which: (i) are mounted on the printing system at first and second locations, respectively, along an axis of the ITM, and (ii) are configured to direct first and second IR beams to first and second positions, respectively, on the surface of the ITM. In other embodiments, at least part of the first and second IR beams overlap one another. In yet other embodiments, at least one of the first and second sensing assemblies includes the IR light source and the sensor integrated together.

In some embodiments, the ITM is configured to absorb the IR beams, and the second signal is indicative of zero IR radiation emitted from the ITM. In other embodiments, the optical assembly includes at least one of: (i) a video camera, and (ii) an optical scanner. In yet other embodiments, the ITM is moved along a first axis, and the one or more sensors of the optical assembly are arranged along a second axis, different from the first axis.

In some embodiments, the second axis is orthogonal to the first axis. In other embodiments, the system includes at least an impression station, which is configured to transfer the image from the ITM to the target substrate, and the optical assembly is positioned, along the first axis, subsequent to the impression station. In yet other embodiments, the ITM includes an outer layer configured to receive the ink image, and an inner layer including a matrix that holds particles at respective given locations, the inner layer is configured to receive at least a portion of the optical radiation passing through the outer layer, and the particles are configured to heat the ITM by absorbing at least part of the portion of the optical radiation.

In some embodiments, the system includes one or more magnetic sensors, which are facing the ITM and are configured to produce an additional signal in response to sensing an altered magnetism from the ITM. In other embodiments, the system includes a processor, which is configured to filter out from the signal one or more spikes indicative of a noise in the signal.

In some embodiments, the substance includes at least a portion of a first target substrate configured to receive the ink image from the ITM, the processor is configured to receive an additional signal indicative of a second target substrate being introduced into the printing system, and the processor is configured to stop the operation of the printing system when: (i) the signal is indicative of the substance being carried by the ITM, and (ii) the additional signal is indicative of the second target substrate being introduced into the printing system. In other embodiments, the processor is configured to present an alert when: (i) the signal is indicative of the substance being carried by the ITM, and (ii) no additional target substrate being introduced into the printing system.

There is additionally provided, in accordance with an embodiment of the present invention, a method for detecting a substance in a printing system, the method including positioning an optical assembly having one or more sensors, to face an intermediate transfer member (ITM), which is adapted to be moved and receive ink droplets from an ink supply subsystem to form an ink image thereon, and to absorb at least part of an optical radiation directed to the ITM for heating the ITM. An optical signal emitted from at least one of the ITM and the substance being carried by the ITM, is sensed, and a signal indicative of the substance is produced.

The present invention will be more fully understood from the following detailed description of the embodiments thereof, taken together with the drawings in which:

### BRIEF DESCRIPTION OF THE DRAWINGS

FIG. 1 is a schematic side view of a digital printing system, in accordance with an embodiment of the present invention;

FIG. 2 is a schematic side view of another digital printing system, in accordance with another embodiment of the present invention;

FIG. 3 is a schematic sectional view of a station for detecting a target substrate being sticked to and carried by a blanket, which is an intermediate transfer member of the systems of FIGS. 1 and 2 above, in accordance with an embodiment of the present invention;

FIG. 4 is a block diagram that schematically illustrates the operation of the station of FIG. 3 above, in accordance with an embodiment of the present invention; and

FIG. 5 is a flow chart that schematically illustrates a method for detecting target substrate being carried by the blanket of the systems of FIGS. 1 and 2 above, in accordance with an embodiment of the present invention.

### DETAILED DESCRIPTION OF EMBODIMENTS

### Overview

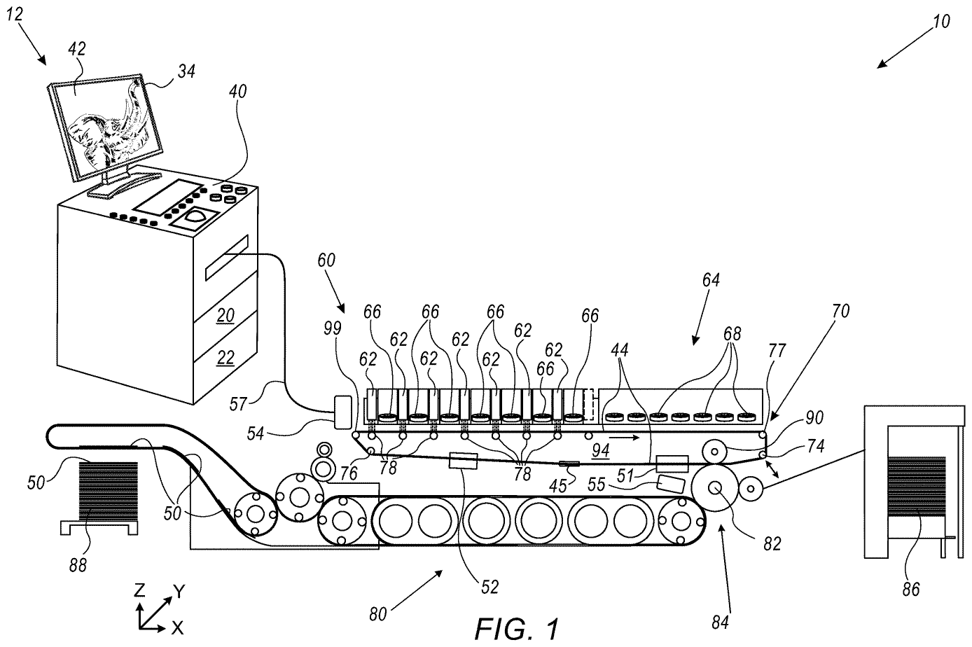

Embodiments of the present invention that are described below provide methods and systems for detecting a target substrate, such as a sheet of paper, which has been sticked to and carried by an intermediate transfer member (ITM) of a digital printing system. In the present example, the ITM is implemented using a flexible blanket, which is described in detail in FIG. 1 below, but the techniques describe below may be applicable to other sorts of flexible and rigid ITMs, such as but not limited to drums used in various sorts of printing systems.

In some embodiments, a digital printing system comprises a printing assembly having: (i) an image forming station configured to apply droplets of printing fluids (e.g., jetting ink droplets) to a surface of the ITM, also referred to herein as a blanket, for producing an image thereon, (ii) an impression station, configured to transfer the image from the blanket to a target substrate (e.g., a sheet), and (iii) a blanket module configured to move the blanket along a first axis (e.g., an X-axis) for (a) producing the image by receiving the ink droplets from the image forming station, and (b) transferring the image to the sheet.

In some embodiments, the blanket comprises a flexible member, which is formed in an endless loop. The blanket is configured to absorb infrared (IR) radiation (also referred to herein as IR light), which may be directed to the blanket surface by a drying station (described in detail in FIG. 1 below) in order to dry the droplets of printing fluids (e.g., ink) applied to the blanket surface for producing the image. It is noted that the target substrate (e.g., paper sheet) is typically adapted to absorb much less of the IR radiation compared to that of the blanket. In some cases, during the operation of the system, (e.g., during a printing process), the target substrate, such as the sheet of paper, may be sticked to and carried by the blanket. In the context of the present disclosure and in the claims, the terms “sticked to,” “adhered to,” and “carried by” are used interchangeably and refer to an event in which a substance such as a portion of sheet 50 or any other foreign material, which is not intended to be on the surface of blanket, is moved together with the blanket. The carried sheet typically interferes with the printing process, and may also cause damage to one or more stations of the printing system.

In some embodiments, the system comprises an optical assembly, which is configured to direct a light beam, in the present example an IR beam, to the blanket surface, and to produce a signal indicative of sensed IR radiation, which is emitted (in the present example, reflected) from the surface responsively to directing the JR beam.

In some embodiments, the optical assembly comprises one or more sensing assemblies, each sensing assembly comprises an IR light source configured to direct the IR beam to the surface of the blanket, and a sensor configured to produce the signal described above. In such embodiments, the IR light source and the sensor may be integrated together in the sensing assembly. In alternative embodiments, the IR light source and the sensor may be separate entities that are mounted on the system at different locations.

In some embodiments, the sensing assemblies are arranged along a second axis of the blanket, in the present example, along a Y-axis that is orthogonal to the X-axis in which the blanket is being moved. For example, the sensing assemblies are arranged along a bar at a predefined distance from the blanket, so that the spots of the IR beams could cover the entire size of the blanket along the Y-axis. In some embodiments, a portion of two adjacent spots may overlap, alternatively, the spots do not overlap with one another. The level of overlapping is typically determined by the opening angle of the IR beam, and the distance between the sensing assemblies and the blanket surface.

In some embodiments, the blanket comprises at least an IR absorbing layer, which is configured to absorb at least part of, and typically, the entire IR radiation of the IR beam emitted from the aforementioned drying station. The target substrate, such as the paper sheet, typically does not have the IR radiation absorption level of the blanket.

In the present disclosure, the IR absorbing attribute of the blanket, is used for detecting whether at least part of the target substrate (e.g., paper sheet) was undesirably sticked to and carried by the surface of the blanket, for example, at the impression station. Additionally, or alternatively, the IR absorption of the blanket may be used for detecting any other material that was undesirably adhered to the blanket surface.

In some embodiments, the sensing assemblies are positioned such that: (i) beam axes of the respective IR beams are approximately perpendicular to the blanket surface, and (ii) the outer surface of the sensors that faces the blanket, is approximately parallel to the blanket surface. This arrangement increases the detection efficiency of IR radiation reflected from the blanket and/or a sheet of paper that was undesirably carried by the blanket. Note that the present invention relies on the properties of the blanket to absorb, most of or all OF the IR radiation, whereas the paper sheet or any other foreign material, which is undesirably carried by the blanket reflects a substantially larger amount of the IR radiation.

In some embodiments, the digital printing system further comprises, a processor, which is configured to receive the signal from the optical assembly, and to control the operation of the printing assembly, inter alia, based on the signal received from the optical assembly. For example, the optical assembly may comprise six sensing assemblies arranged along the Y-axis (i.e., the width) of the blanket. In case a portion of a sheet is undesirably adhered to the blanket, (i) a first sensing assembly may sense IR radiation emitted from the sheet, and (ii) a second sensing assembly may face only the blanket (that absorbs the IR radiation), and therefore, may not sense any (or sense a substantially smaller amount of) IR radiation. In this example, the processor may receive from the first and second sensing assemblies, first and second signals, respectively, which are indicative of the amount of emitted IR radiation. Based on the different amount of IR radiation sensed by the first and second sensing assemblies, the processor is configured to detect the portion of the sheet that was undesirably adhered to the blanket. Additional embodiments are described in the detailed description below.

The disclosed techniques improve the availability and utilization of printing systems using an ITM, and are applicable for digital printing systems as well as for other sorts of printing systems using any suitable type of ITM.

### System Description

FIG. 1 is a schematic side view of a digital printing system 10, in accordance with an embodiment of the present invention. In some embodiments, system 10 comprises a rolling flexible blanket 44 that cycles through an image forming station 60, a drying station 64, an impression station 84 and a blanket treatment station 52. In the context of the present invention and in the claims, the terms “blanket” and “intermediate transfer member (ITM)” are used interchangeably and refer to a flexible member comprising one or more layers used as an intermediate member, which is formed in an endless loop configured to receive an ink image, e.g., from image forming station 60, and to transfer the ink image to a target substrate, as will be described in detail below.

In an operative mode, image forming station 60 is configured to form a mirror ink image, also referred to herein as “an ink image” (not shown) or as an “image” for brevity, of a digital image 42 on an upper run of a surface of blanket 44. Subsequently the ink image is transferred to a target substrate, (e.g., a paper, a folding carton, a multilayered polymer, or any suitable flexible package in a form of sheets or continuous web) located under a lower run of blanket 44.

In the context of the present invention, the term “run” refers to a length or segment of blanket 44 between any two given rollers over which blanket 44 is guided.

In some embodiments, during installation, blanket 44 may be adhered edge to edge, using a seam section also referred to herein as a seam 45, so as to form a continuous blanket loop, also referred to herein as a closed loop. An example of a method and a system for the installation of the seam is described in detail in U.S. Patent Application Publication 2020/0171813, whose disclosure is incorporated herein by reference.

In some embodiments, image forming station 60 typically comprises multiple print bars 62, each print bar 62 mounted on a frame (not shown) positioned at a fixed height above the surface of the upper run of blanket 44. In some embodiments, each print bar 62 comprises a strip of print heads as wide as the printing area on blanket 44 and comprises individually controllable printing nozzles configured to jet ink and other sort of printing fluids to blanket 44 as described in detail below.

In some embodiments, image forming station 60 may comprise any suitable number of print bars 62, also referred to herein as bars 62, for brevity. Each bar 62 may contain a printing fluid, such as an aqueous ink of a different color. The ink typically has visible colors, such as but not limited to cyan, magenta, red, green, blue, yellow, black, and white. In the example of FIG. 1, image forming station 60 comprises seven print bars 62, but may comprise, for example, four print bars 62 having any selected colors such as cyan (C), magenta (M), yellow (Y) and black (K).

In some embodiments, the print heads are configured to jet ink droplets of the different colors onto the surface of blanket 44 so as to form the ink image (not shown) on the surface of blanket 44. In the present example, blanket 44 is moved along an X-axis of an XYZ coordinate system of system 10, and the ink droplets are directed by the print heads, typically approximately parallel to a Z-axis of the coordinate system.

In some embodiments, different print bars 62 are spaced from one another along the movement axis, also referred to herein as (i) a moving direction 94 of blanket 44 or (ii) a printing direction. In the present example, the moving direction of blanket 44 is parallel to the X-axis, and each print bar 62 is extended along a Y-axis of the XYZ coordinates of system 10. In this configuration, accurate spacing between bars 62 along an X-axis, and synchronization between directing the droplets of the ink of each bar 62 and moving blanket 44 are essential for enabling correct placement of the image pattern.

In the context of the present disclosure and in the claims, the terms “inter-color pattern placement,” “pattern placement accuracy,” “color-to-color registration,” “C2C registration,” and “color registration” are used interchangeably and refer to any placement accuracy of two or more colors relative to one another.

In some embodiments, system 10 comprises heaters 66, such as hot gas or air blowers and/or infrared-based heaters with gas or air blowers for flowing gas or air at any suitable temperature. Heaters 66 are positioned in between print bars 62, and are configured to partially dry the ink droplets deposited on the surface of blanket 44. This air flow between the print bars may assist, for example, (i) in reducing condensation at the surface of the print heads and/or in handling satellites (e.g., residues or small droplets distributed around the main ink droplet), and/or (ii) in preventing clogging of the orifices of the inkjet nozzles of the print heads, and/or (iii) in preventing the droplets of different color inks on blanket 44 from undesirably merging into one another.

In some embodiments, system 10 comprises drying station 64, configured to direct infrared (IR) radiation and cooling air (or another gas), and/or to blow hot air (or another gas) onto the surface of blanket 44. In some embodiments, drying station 64 may comprise infrared-based illumination assemblies (not shown) and/or air blowers 68 or any other suitable drying apparatus.

In some embodiments, in drying station 64, the ink image formed on blanket 44 is exposed to radiation and/or to hot air in order to dry the ink more thoroughly, evaporating most or all of the liquid carrier and leaving behind only a layer of resin and coloring agent which is heated to the point of being rendered a tacky ink film.

In some embodiments, blanket 44 comprises an IR layer (not shown) having an exemplary thickness between about 30 μm and 150 μm, and configured to absorb the entire IR radiation of the IR beam emitted from drying station 64, or at least a significant portion thereof. The implementation of the IR layer in blanket 44 and the IR radiation in drying station 64 is described in detail, for example, in PCT application PCT/IB2020/060552, whose disclosure is incorporated herein by reference.

In some embodiments, system 10 comprises a blanket module 70, also referred to herein as an ITM module, comprising a rolling flexible ITM, such as blanket 44. In some embodiments, blanket module 70 comprises one or more rollers 78, wherein at least one of rollers 78 comprises a motion encoder (not shown), which is configured to record the position of blanket 44, so as to control the position of a section of blanket 44 relative to a respective print bar 62. In some embodiments, one or more motion encoders may be integrated with additional rollers and other moving components of system 10.

In some embodiments, the aforementioned motion encoders typically comprise at least one rotary encoder configured to produce rotary-based position signals indicative of an angular displacement of the respective roller. Note that in the context of the present invention and in the claims, the terms “indicative of” and “indication” are used interchangeably.

Additionally, or alternatively, blanket 44 may comprise an integrated encoder (not shown) for controlling the operation of various modules of system 10. One implementation of the integrated motion encoder is described in detail, for example, in PCT International Publication WO 2020/003088, whose disclosure is incorporated herein by reference.

In some embodiments, blanket 44 is guided in blanket module 70 over rollers 76, 78 and other rollers described herein, and over a powered tensioning roller, also referred to herein as a dancer assembly 74. Dancer assembly 74 is configured to control the length of slack in blanket 44 and its movement is schematically represented in FIG. 1 by a double-sided arrow. Furthermore, any stretching of blanket 44 with aging would not affect the ink image placement performance of system 10 and would merely require the taking up of more slack by tensioning dancer assembly 74.

In some embodiments, dancer assembly 74 may be motorized. The configuration and operation of rollers 76 and 78 are described in further detail, for example, in U.S. Patent Application Publication 2017/0008272 and in the above-mentioned PCT International Publication WO 2013/132424, whose disclosures are all incorporated herein by reference.

In some embodiments, system 10 comprises a blanket tension drive roller (BTD) 99 and a blanket control drive roller (BCD) 77, which are powered by respective first and second motors, typically electric motors (not shown) and are configured to rotate about their own first and second axes, respectively.

In some embodiments, system 10 may comprise one or more tension sensors (not shown) disposed at one or more positions along blanket 44. The tension sensors may be integrated in blanket 44 or may comprise sensors external to blanket 44 using any other suitable technique to acquire signals indicative of the mechanical tension applied to blanket 44. In some embodiments, processor 20 and additional controllers of system 10 are configured to receive the signals produced by the tension sensors, so as to monitor the tension applied to blanket 44 and to control the operation of dancer assembly 74.

In impression station 84, blanket 44 passes between an impression cylinder 82 and a pressure cylinder 90, which is configured to carry a compressible blanket. In some embodiments, a motion encoder is integrated with at least one of impression cylinder 82 and pressure cylinder 90.

In some embodiments, system 10 comprises a control console 12, which is configured to control multiple modules of system 10, such as blanket module 70, image forming station 60 located above blanket module 70, and a substrate transport module 80, which is located below blanket module 70 and comprises one or more impression stations as will be described below.

In some embodiments, console 12 comprises a processor 20, typically a general-purpose processor, with suitable front end and interface circuits for interfacing with controllers of dancer assembly 74 and with a controller 54, via a cable 57, and for receiving signals therefrom. Additionally, or alternatively, console 12 may comprise any suitable type of an application-specific integrated circuit (ASIC) and/or a digital signal processor (DSP) and/or any other suitable sort of processing unit configured to carry out any sort of processing for data processed in system 10.

In some embodiments, controller 54, which is schematically shown as a single device, may comprise one or more electronic modules mounted on system 10 at predefined locations. At least one of the electronic modules of controller 54 may comprise an electronic device, such as control circuitry or a processor (not shown), which is configured to control various modules and stations of system 10. In some embodiments, processor 20 and the control circuitry may be programmed in software to carry out the functions that are used by the printing system, and store data for the software in a memory 22. The software may be downloaded to processor 20 and to the control circuitry in electronic form, over a network, for example, or it may be provided on non-transitory tangible media, such as optical, magnetic or electronic memory media.

In some embodiments, console 12 comprises a display 34, which is configured to display data and images received from processor 20, or inputs inserted by a user (not shown) using input devices 40. In some embodiments, console 12 may have any other suitable configuration, for example, an alternative configuration of console 12 and display 34 is described in detail in U.S. Pat. No. 9,229,664, whose disclosure is incorporated herein by reference.

In some embodiments, processor 20 is configured to display on display 34, a digital image 42 comprising one or more segments (not shown) of image 42 and/or various types of test patterns that may be stored in memory 22.

In some embodiments, blanket treatment station 52, also referred to herein as a cooling station, is configured to treat the blanket by, for example, cooling it and/or applying a treatment fluid to the outer surface of blanket 44, and/or cleaning the outer surface of blanket 44. At blanket treatment station 52, the temperature of blanket 44 can be reduced to a desired temperature-level before blanket 44 enters into image forming station 60. The treatment may be carried out by passing blanket 44 over one or more rollers or blades configured for applying cooling and/or cleaning and/or treatment fluid to the outer surface of the blanket.

In some embodiments, blanket treatment station 52 may further comprise one or more bars (not shown) positioned adjacent to print bars 62, so that the treatment fluid may additionally or alternatively be applied to blanket 44 by jetting.

In some embodiments, processor 20 is configured to receive, e.g., from temperature sensors (not shown), signals indicative of the surface temperature of blanket 44, so as to monitor the temperature of blanket 44 and to control the operation of blanket treatment station 52. Examples of such treatment stations are described, for example, in PCT International Publications WO 2013/132424 and WO 2017/208152, whose disclosures are all incorporated herein by reference.

In the example of FIG. 1, station 52 is mounted between impression station 84 and image forming station 60, yet, station 52 may be mounted adjacent to blanket 44 at any other or additional one or more suitable locations between impression station 84 and image forming station 60. As described above, station 52 may additionally or alternatively be mounted on a bar adjacent to image forming station 60.

In the example of FIG. 1, impression cylinder 82 and pressure cylinder 90 impress the ink image onto the target flexible substrate, such as an individual sheet 50, conveyed by substrate transport module 80 from an input stack 86 to an output stack 88 via impression station 84. In the present example, a rotary encoder (not shown) is integrated with impression cylinder 82.

In some embodiments, the lower run of blanket 44 selectively interacts at impression station 84 with impression cylinder 82 to impress the image pattern onto the target flexible substrate compressed between blanket 44 and impression cylinder 82 by the action of pressure of pressure cylinder 90. In the case of a simplex printer (i.e., transferring the image to one side of sheet 50) shown in FIG. 1, only one impression station 84 is needed.

In some cases, at least a portion of sheet 50 may be sticked to and carried by blanket 44, for example, while transferring the image from blanket 44 to sheet 50 in impression station 84. In some embodiments, system 10 comprises a station 51, which is configured to produce a signal indicative of at least a portion of sheet 50, or any other sort of substance, also referred to herein as foreign material, which was sticked to and carried by blanket 44. In some embodiments, based on the signal received from station 51, processor 20 is configured to control the operation of system 10. In the context of the present disclosure and in the claims, the terms “substance” and “foreign material” are used interchangeably and refer to any sort of material that was undesirably adhered to the surface of blanket 44.

In the example embodiment of FIG. 1, station 51 is mounted on system 10 in proximity with impression station 82. More specifically, station 51 is positioned subsequent to impression station 84 along the movement axis of blanket 44. In this embodiment, in case sheet 50, or a portion thereof, has undesirably being carried by blanket 44, processor 20 may immediately receive from station 51 a signal indicative of this event. In other words, after at least a portion of sheet 50 has being sticked to and carried by a section of blanket 44, the section of blanket 44 is being moved along the movement axis near station 51, which outputs the signal indicative of the portion of sheet 50 being carried by the section of blanket 44. In response to receiving the signal, processor 20 is configured to display a warning and/or stop the operation of system 10.

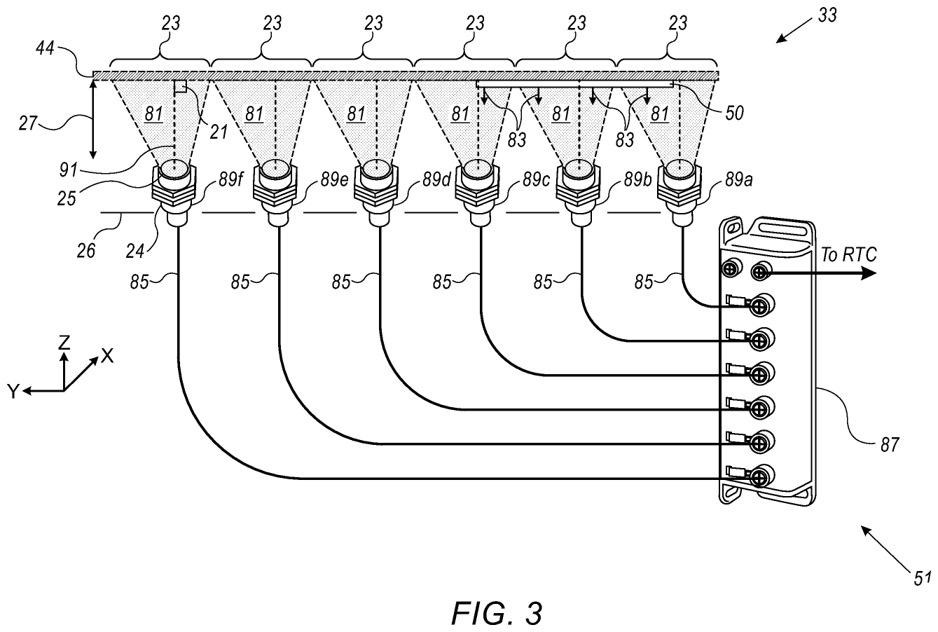

Embodiments related to station 51, and control operations of system 10 based on signals received from station 51, are described in detail is FIGS. 3, 4 and 5 below.

In some embodiments, sheets 50 or continuous web substrate (not shown) are carried by module 80 from input stack 86 and pass through the nip (not shown) located between impression cylinder 82 and pressure cylinder 90. Within the nip, the surface of blanket 44 carrying the ink image is pressed firmly, e.g., by the compressible blanket of pressure cylinder 90, against sheet 50 (or against another suitable substrate) so that the ink image is impressed onto the surface of sheet 50 and separated neatly from the surface of blanket 44. Subsequently, sheet 50 is transported to output stack 88.

In the example of FIG. 1, rollers 78 are positioned at the upper run of blanket 44 and are configured to maintain blanket 44 taut when passing adjacent to image forming station 60. Furthermore, it is particularly important to control the speed of blanket 44 below image forming station 60 so as to obtain accurate jetting and deposition of the ink droplets to form an image, by image forming station 60, on the surface of blanket 44.

In some embodiments, impression cylinder 82 is periodically engaged with and disengaged from blanket 44, so as to transfer the ink images from moving blanket 44 to the target substrate passing between blanket 44 and impression cylinder 82. In some embodiments, system 10 is configured to apply torque to blanket 44 using the aforementioned rollers and dancer assemblies, so as to maintain the upper run taut and to substantially isolate the upper run of blanket 44 from being affected by mechanical vibrations occurring in the lower run.

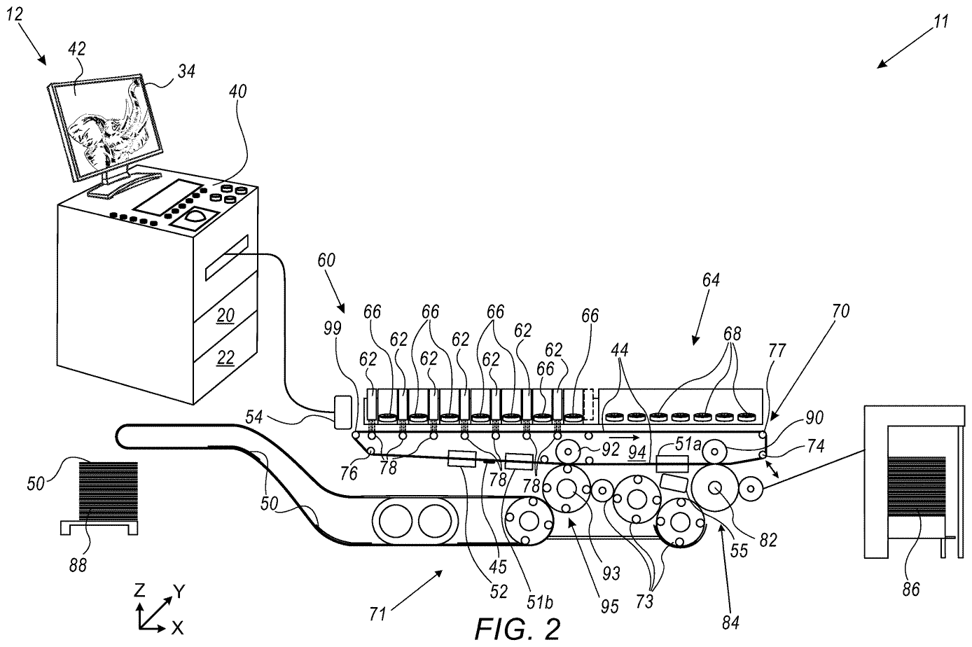

Reference is now made to FIG. 2, which is a schematic side view of a digital printing system 11, in accordance with another embodiment of the present invention.

In some embodiments, system 11 comprises a duplex system having a module 71 (instead of module 80 shown in system 10 of FIG. 1 above). In the present example, system 11 comprises impression station 84 (described in FIG. 1), and an additional impression station 95 having an impression cylinder 93 and a pressure cylinder 92.

In some embodiments, after transferring a first image from blanket 44 to a first side of a given sheet 50 (as described in FIG. 1 above), processor 20 is configured to: (i) move given sheet 50 via cylinders 73 for flipping given sheet 50, and subsequently, (ii) control impression cylinder 93 and pressure cylinder 92 to impress a second ink image formed on blanket 44 onto a second side given sheet 50.

In some embodiments, the configuration of system 11, and more specifically the availability of both impression stations 84 and 95, permits a duplex printing. In the context of the present disclosure (and in the claims), the term “duplex printing” refers to printing on both sides of sheet 50 (or any other target substrate). Moreover, the configuration of two impression cylinders may also enable conducting single sided prints at higher (e.g., twice) the speed of printing double sided prints. In addition, mixed lots of single-sides and double-sided prints can also be printed. In alternative embodiments, a different configuration of module 80 (of system 10) or module 71 (of system 11) may be used for printing on a continuous web substrate. Detailed descriptions and various configurations of duplex printing systems and of systems for printing on continuous web substrates are provided, for example, in U.S. Pat. Nos. 9,914,316 and 9,186,884, in PCT International Publication WO 2013/132424, in U.S. Patent Application Publication 2015/0054865, and in U.S. Provisional Application 62/596,926, whose disclosures are all incorporated herein by reference.

In some embodiments, system 11 comprises one or more stations 51 configured to detect events in which a portion of sheet 50 (or any other foreign material) has been sticked to and carried by the surface of blanket 44. In the example embodiment of FIG. 2, system 11 comprises a first station 51a disposed near impression station 84, and a second station 51b disposed near impression station 95. In this example configuration, stations 51a and 51b are configured to detect events of sticked sheet(s) 50 in impression stations 84 and 95, respectively.

In other embodiments, system 11 may comprise any other configuration of one or more stations 51 disposed at any other suitable position(s) along blanket 44. For example, system 11 may comprise only station 51b located near impression station 95 as shown in FIG. 2. Additionally, or alternatively, system 10 of FIG. 1 above may comprise one or more stations 51 disposed at any other suitable position(s) along blanket 44.

Reference is now made back to FIG. 1.

In some embodiments, system 10 comprises an image quality control station 55, also referred to herein as an automatic quality management (AQM) system, which serves as a closed loop inspection system integrated in system 10. In some embodiments, image quality control station 55 may be positioned adjacent to impression cylinder 82, as shown in FIG. 1, or at any other suitable location in system 10.

In some embodiments, image quality control station 55 comprises a camera (not shown), which is configured to acquire one or more digital images of the aforementioned ink image printed on sheet 50. In some embodiments, the camera may comprise any suitable image sensor, such as a Contact Image Sensor (CIS) or a Complementary metal oxide semiconductor (CMOS) image sensor, and a scanner comprising a slit having a width of about one meter or any other suitable width.

In the context of the present disclosure and in the claims, the terms “about” or “approximately” for any numerical values or ranges indicate a suitable dimensional tolerance that allows the part or collection of components to function for its intended purpose as described herein.

In some embodiments, the digital images acquired by station 55 are transmitted to a processor, such as processor 20 or any other processor of station 55, which is configured to assess the quality of the respective printed images. Based on the assessment and signals received from controller 54, processor 20 is configured to control the operation of the modules and stations of system 10. In the context of the present invention and in the claims, the term “processor” refers to any processing unit, such as processor 20 or any other processor or controller connected to or integrated with station 55, which is configured to process signals received from the camera and/or the spectrophotometer of station 55. Note that the signal processing operations, control-related instructions, and other computational operations described herein may be carried out by a single processor, or shared between multiple processors of one or more respective computers.

In some embodiments, station 55 is configured to inspect the quality of the printed images and test pattern so as to monitor various attributes, such as but not limited to full image registration with sheet 50, also referred to herein as image-to-substrate registration, color-to-color (C2C) registration, printed geometry, image uniformity, profile and linearity of colors, and functionality of the print nozzles. In some embodiments, processor 20 is configured to automatically detect geometrical distortions or other errors in one or more of the aforementioned attributes.

In some embodiments, one or more image quality control stations 55 may be used instead of or in addition to station 51, so as to detect at least a portion of sheet 50 that was sticked to and carried by blanket 44. In such embodiments, the scanner of at least one of image quality control stations 55 is configured to produce the signal indicative of the at least a portion of sheet 50 that was carried by blanket 44. Note that based on this technique, the scanner may acquire images of blanket 44, and produce signals indicative of the acquired images. In such embodiments, processor 20 is configured to apply any suitable image processing algorithm(s) to identify whether a portion of sheet 50 has been carried by blanket 44.

Additionally, or alternatively, system 10 may comprise one or more video cameras (not shown), which may be disposed in proximity to blanket 44. The video cameras are configured to acquire images of blanket 44, and produce signals indicative of the acquired images, and processor 20 is configured to apply any suitable image processing algorithm(s) to identify whether a portion of sheet 50 has been sticked to and carried by blanket 44.

In some embodiments, processor 20 is configured to analyze the detected distortion in order to apply a corrective action to the malfunctioning module, and/or to feed instructions to another module or station of system 10, so as to compensate for the detected distortion.

In some embodiments, system 10 may print testing marks (not shown) or other suitable features, for example at the bevels or margins of sheet 50. By acquiring images of the testing marks, station 55 is configured to measure various types of distortions, such as C2C registration, image-to-substrate registration, different width between colors referred to herein as “bar to bar width delta” or as “color to color width difference”, various types of local distortions, and front-to-back registration errors (in duplex printing). In some embodiments, processor 20 is configured to: (i) sort out, e.g., to a rejection tray (not shown), sheets 50 having a distortion above a first predefined set of thresholds, (ii) initiate corrective actions for sheets 50 having a distortion above a second, lower, predefined set of threshold, and (iii) output sheets 50 having minor distortions, e.g., below the second set of thresholds, to output stack 88.

In some embodiments, processor 20 is configured to detect, based on signals received from the spectrophotometer of station 55, deviations in the profile and linearity of the printed colors.

In some embodiments, the processor of station 55 is configured to decide whether to stop the operation of system 10, for example, in case the density of distortions is above a specified threshold. The processor of station 55 is further configured to initiate a corrective action in one or more of the modules and stations of system 10, as described above. In some embodiments, the corrective action may be carried out on-the-fly (while system 10 continues the printing process), or offline, by stopping the printing operation and fixing the problem in respective modules and/or stations of system 10. In other embodiments, any other processor or controller of system 10 (e.g., processor 20 or controller 54) is configured to start a corrective action or to stop the operation of system 10 in case the density of distortions is above a specified threshold.

Additionally, or alternatively, processor 20 is configured to receive, e.g., from station 55, signals indicative of additional types of distortions and problems in the printing process of system 10. Based on these signals, processor 20 is configured to automatically estimate the level of pattern placement accuracy and additional types of distortions and/or defects not mentioned above. In other embodiments, any other suitable method for examining the pattern printed on sheets 50 (or on any other substrate described above) can also be used, for example, using an external (e.g., offline) inspection system, or any type of measurements jig and/or scanner. In these embodiments, based on information received from the external inspection system, processor 20 is configured to initiate any suitable corrective action and/or to stop the operation of system 10.

The configuration of system 10 is simplified and provided purely by way of example for the sake of clarifying the present invention. The components, modules and stations described in printing system 10 hereinabove and additional components and configurations are described in detail, for example, in U.S. Pat. Nos. 9,327,496 and 9,186,884, in PCT International Publications WO 2013/132438, WO 2013/132424 and WO 2017/208152, in U.S. Patent Application Publications 2015/0118503 and 2017/0008272, whose disclosures are all incorporated herein by reference.

The particular configurations of systems 10 and 11 are shown by way of example, in order to illustrate certain problems that are addressed by embodiments of the present invention and to demonstrate the application of these embodiments in enhancing the performance of such systems. Embodiments of the present invention, however, are by no means limited to this specific sort of example systems, and the principles described herein may similarly be applied to any other sorts of printing systems.

FIG. 3 is a schematic sectional view of a station 51 for detecting at least a portion of sheet 50 being sticked to and carried by blanket 44, in accordance with an embodiment of the present invention.

In some embodiments, station 51 comprises an optical assembly (OA) 33, and a gateway logic, also referred to herein as a gateway 87, whose functionality is described in detail below.

In some embodiments, OA 33 comprises one or more sensing assemblies (SAs), in the present example six SAs 89a, 89b, 89c, 89d, 89e, 89f, each of which is configured to: (i) direct an infrared (IR) beam 81 to the surface of blanket 44, and (ii) produce a signal indicative of sensed IR radiation, which is emitted (e.g., reflected) from the surface of blanket 44 responsively to IR beam 81 impinging on blanket 44. In the present example, each SA 89 comprises a light source 24, also referred to herein as a light source assembly, which is configured to emit and direct IR beam 81 to the surface of blanket 44. IR beam 81 may have any suitable IR wavelength between about 810 nm and 850 nm, and may comprise a constant light and/or a flickering light. Each SA 89 further comprises a sensor 25, which is configured to produce a signal indicative of the sensed IR radiation emitted (e.g., reflected) from blanket 44, and to transfer the signal to gateway 87 via an electrical cable 85. In alternative embodiments, light source 24 may not be integrated in SA 89, but in a separate assembly.

In some embodiments, gateway 87 comprises an off-the-shelf gateway logic, such as but not limited to IO-Link Hub part number 1089792 produced by SICK (Erwin-Sick-Str. 1, Waldkirch 79183, Germany). In other embodiments, gateway 87 comprises an application-specific gateway controller that may be developed to carry out the applications described herein.

In some embodiments, SAs 89a-89f are mounted on a bar 26 along the Y-axis of blanket 44, such that when blanket 44 is being moved along the x-axis, IR beams 81 form spots 23 that may cover the entire width of blanket 44. In the example of FIG. 3, SAs 89 are positioned at a distance 27 from the surface of blanket 44, so that in some embodiments, each pair of adjacent spots 23 may have some overlap therebetween. Moreover, bar 26 and SAs 89 are positioned relative to the surface of blanket 44 such that a beam axis 91 of beam 81 is approximately perpendicular to the surface of blanket 44, i.e., having an angle 21 between beam axis 91 and the surface of blanket 44 comprises a right angle. Furthermore, the outer surface of sensor 25, which is facing blanket 44, is approximately parallel to the surface of blanket 44, so as to improve the detection efficiency of the IR radiation emitted from the surface of blanket 44.

In other embodiments, optical assembly 33 may have one or more variations, such as but not limited to: (i) beam axis 91 may not be perpendicular to the surface of blanket 44 (i.e., angle 21 may not be a right angle), so as to obtain an oblique spot 23, (ii) OA 33 may comprise any other suitable number of SAs 89, (iii) spots 23 may not cover the entire width of blanket 44, and/or may not have overlap therebetween, (iv) SAs 89 may be positioned on bar 26 or on any other suitable apparatus using any other suitable arrangement, other than along the Y-axis of blanket 44, and (v) distance 27 may be altered between each SA 89 and the surface of blanket 44.

As described in FIG. 1 above, blanket 44 comprises an IR layer (not shown) configured to absorb IR radiation, whereas sheet 50 absorbs a substantially smaller amount of IR radiation. In some embodiments, in response to directing IR beam 81, blanket 44 is configured to absorb at least part of, and typically the entire IR radiation of IR beam 81 emitted from optical assembly 33.

In the example of FIG. 3, a portion of sheet 50 (or any other foreign material) has been sticked or otherwise adhered to a given area of blanket 44, e.g., while transferring the image at impression station 84. In some embodiments, light sources 24 of sensing assemblies 89a-89f are directing IR beams 81 to the surface of blanket 44, and when the given area of blanket passes near OA 33, beams 81 impinge on the surface of blanket 44, and also, on the surface of the portion of sheet 50. As described above, blanket 44 is configured to absorb the IR radiation, but some IR radiation 83 is emitted (e.g., reflected) from sheet 50 toward SAs 89a-89c.

In some embodiments, the signals produced by SAs 89d-89f are indicative that (almost) no IR radiation has been detected by sensors 25 thereof, whereas the signals from SAs 89a-89c are indicative of IR radiation 83 being detected by SAs 89a-89c. Note that all SAs 89 direct similar beams 81 toward blanket 44, but only SAs 89a-89c detect IR radiation 83, which may be indicative of the sticked portion of sheet 50.

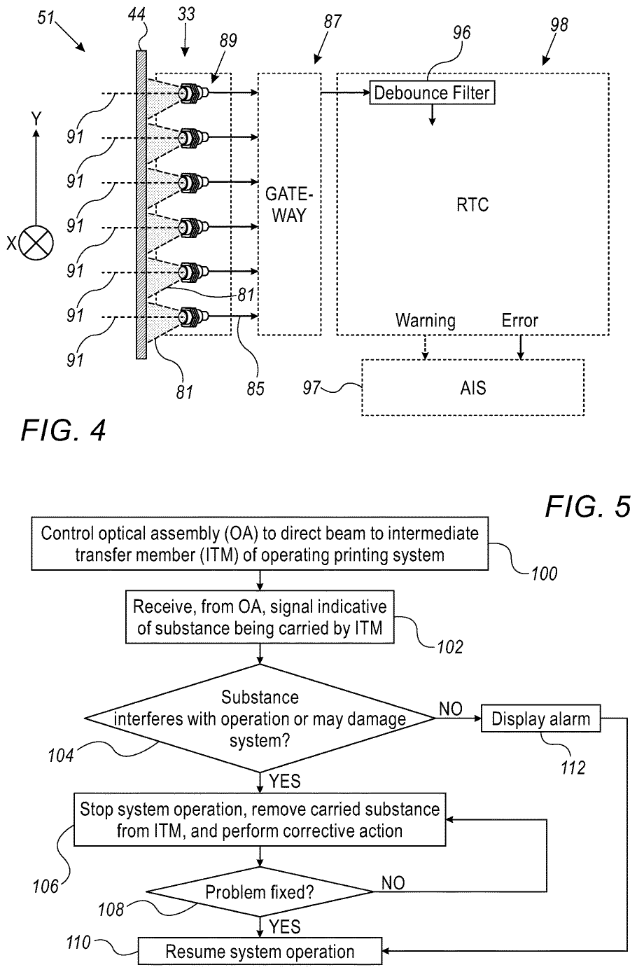

In some embodiments, gateway 87 is configured to receive the signals from SAs 89a-89f and transfer the signals to a real-time controller (RTC) shown and described in detail in FIG. 4 below.

The particular configuration of systems OA 33 is shown by way of example, in order to illustrate certain problems that are addressed by embodiments of the present invention and to demonstrate the application of these embodiments in enhancing the performance of such systems. Embodiments of the present invention, however, are by no means limited to this specific sort of example optical assembly, and the principles described herein may similarly be applied to any other sorts of suitable type of sensing assemblies.

As described above, SAs 89 are configured to direct IR beam 81 to the surface of blanket 44, and produce the signal indicative of sensed IR radiation reflected from the surface of blanket 44. In other embodiments, blanket 44 may comprise magnetic materials, and in addition to or instead of SAs 89, OA 33 may comprise one or more magnetic sensors, which are facing blanket 44 and are configured to produce an additional signal in response to sensing an altered magnetism from blanket 44. Note that (i) when blanket 44 does not carry the foreign substance, such as sheet 50 or a portion thereof, the signal produced by magnetic sensors may have a known profile of magnetism, and (ii) the magnetism between at least one of the magnetic sensors and blanket 44 may be altered from the known profile when blanket 44 carries at least a portion of sheet 50 (or any other foreign material). Thus, the additional signal produced by at least one of the magnetic sensors may be indicative of at least a portion of sheet 50, or any other foreign material, being sticked to and/or carried by blanket 44.

FIG. 4 is a block diagram that schematically illustrates the operation of station 51, in accordance with an embodiment of the present invention.

As described, inter alia, in FIG. 1 above, during the operation of system 10, blanket 44 is being moved along the X-axis, which is approximately perpendicular to the plain of FIG. 4. Moreover, while blanket 44 is being moved along the X-axis, processor 20 is configured to control OA 33 to direct IR beams 81 toward blanket 44. As described in FIG. 3 above, IR beams are directed along beam axis 91, which is approximately perpendicular to blanket 44. In the context of the present disclosure and in the claims, the terms “perpendicular” and “orthogonal” are used interchangeably.

In some embodiments, SAs 89a-89f are configured to produce signals indicative of the amount of IR radiation emitted from blanket 44 (and foreign materials, such as at least a portion of sheet 50 that may undesirably being sticked to the surface of and carried by blanket 44, as described in detail in FIG. 3 above) responsively to receiving IR beams 81 directed by OA 33.

In some embodiments, gateway 87 is configured to receive the signals from SAs 89a-89f via respective cables 85. Note that each SA 89 has a separate channel, so that in the present example, SAs 89a-89f are configured to transfer six signals, respectively, to a real-time controller (RTC) 98.

In some embodiments, RTC 98 may be implemented in processor 20 and/or in controller 54 described in FIG. 1 above. Moreover, both processor 20 and controller 54 are configured to control at least one of: (i) OA 33 to direct IR beams 81 and produce the signals indicative of the IR radiation being emitted from blanket 44, and (ii) gateway 87 to receive the signals from OA 33 and transfer them to RTC 98.

In some embodiments, RTC 98 comprises a filter, in the present example, a debounce filter 96, which is configured to filter out, from the signals received from SAs 89a-89f, one or more spikes indicative of noise in the respective signals. As shown in the example of FIG. 3 above, (i) a first signal produced by SA 89b (which is facing blanket 44 and sheet 50, and therefore, senses IR radiation 83 emitted from sheet 50) is indicative of emission of IR radiation 83. and (ii) a second signal produced by SA 89f (which is facing blanket 44, and therefore, does not sense emission of IR radiation 83), may have an electrical spike caused by undesired noise. In this example, debounce filter 96 is configured to filter out the electrical spike, so that RTC 98 receives: (i) the first signal (from SA 89b) indicative of the portion of sheet 50 being carried by blanket 44, and (ii) the second signal that is based on no emission of IR radiation 83, and therefore, is indicative of no substance being carried by blanket 44.

In some embodiments, RTC 98 is configured to receive (e.g., from a sensor located between input stack 86 and impression station 84, or from processor 20) an additional signal, which is indicative of an additional sheet 50 being introduced into system 10, and more specifically, into one or both of impression stations 84 and 95. In some embodiments, RTC 98 that is implemented in processor 20, is configured to stop the operation of system 10 when: (i) the one or more signals from OA 33 are indicative of the portion of sheet 50 being carried by blanket 44, and (ii) the additional signal is indicative of one or more additional sheets being introduced into system 10. In other words, when identifying a foreign material being carried by blanket 44 while system 10 is printing product or testing images, processor 20 is configured to stop the operation of system 10 for fixing the problem. Additionally, or alternatively, processor 20 is configured to control system 10 to remove the foreign material while printing product or testing images. Example techniques for removing foreign material from blanket 44 are described in detail in PCT International Publication WO 2019/106510, whose disclosure is incorporated herein by reference.

In other embodiments, RTC 98 that is implemented in processor 20, is configured to present an alarm message (e.g., on display 34) when: (i) the one or more signals from OA 33 are indicative of the portion of sheet 50 being carried by blanket 44, and (ii) no additional sheet 50 is being introduced into system 10. This example may happen during maintenance or while recovering system 10 during or after any sort of maintenance operation carried out on system 10. In other words, when identifying a foreign material being carried by blanket 44 while system 10 is not printing product or testing images, processor 20 is configured to display an alert or any other suitable type of warning, but may not necessarily stop the operation of system 10. More specifically, in case blanket 44 is not being moved, it is sufficient to display the alert, so that a user or a technician of system 10 may remove the substance (e.g., the portion of sheet 50) being carried by blanket 44.

In some embodiments, processor 20, or RTC 98 that is implemented in processor 20, is configured to activate at least one of stations 51, 51a and 51b, in response to receiving the additional signal or any other signal indicative of blanket 44 being moved within system 10.

In some embodiments, system 10 comprises application interface software (AIS) 97, which is implemented also in processor 20 (and optionally, also in controller 54). In response to receiving from gateway 87 the signal indicative of a portion of sheet 50 being carried by blanket 44, RTC 98 is configured to send a warning signal and/or an error signal, to AIS 97 for displaying the warning and/or for stopping the operation of system 10.

The particular configuration of station 51 is shown by way of example, in order to illustrate certain problems that are addressed by embodiments of the present invention and to demonstrate the application of these embodiments in enhancing the performance of such systems. Embodiments of the present invention, however, are by no means limited to this specific sort of example station, and the principles described herein may similarly be applied to any other sorts of station(s) configured to produce a signal indicative of at least a portion of sheet 50, or any other sort of substance, which is undesirably carried by blanket 44.

FIG. 5 is a flow chart that schematically illustrates a method for controlling the operation of system 10 in response to detecting substance, such as sheet 50, being carried by blanket 44, in accordance with an embodiment of the present invention.

The method begins at a beam directing step 100 with processor 20 controlling OA 33 to direct IR beam 81 to the surface of blanket 44 (which is typically being moved), as described in detail in FIGS. 3 and 4 above.

At a signal receiving step 102, processor 20 receives, from OA 33, one or more signals indicative of whether a substance, such as sheet 50 or a portion thereof, is carried by the surface of blanket 44, as described in detail in FIGS. 1-4 above.

At a first decision step 104, processor 20 checks whether the sticked substance interferes with the operation of system 10 (e.g., while system 10 is printing) and/or may cause damage to one or more components of system 10, as described in detail in FIGS. 1-4 above.

In case the sticked substance interferes with the operation and/or may cause damage to one or more components of system 10, the method proceeds to a corrective action step 106, in which processor 20 controls system 10 to stop operations, the sticked substance is being removed from blanket 44, and if applicable, a corrective action is carried out in order to prevent a repeating event of substance being sticked to and/or carried by blanket 44.

At a second decision step 108, processor 20 is configured to: (i) receive information about the corrective actions and testing carried out in step 106 above, and (ii) check whether the problem was fixed, e.g., based on testing data and fulfilled checklists, or based on a manual or automatic input from a user of system 10.

In case the problem was not fixed, the method loops back to step 106.

In case the problem was fixed, then at a resuming step 110 that concludes the method, processor 20 controls system 10 to resume the operation being stopped at step 106 above, as described in FIG. 4 above.

Reference is now made back to step 104 above. In case the sticked substance does not interfere with the operation of system 10, and cannot cause any damage to any component of system 10, the method proceeds to an alarm display step 112, in which processor 20 is configured to display, e.g., on display 34, an alarm message indicative of the substance being carried by the surface of blanket 44. For example, during a maintenance operation in which some stations of system 10 are sufficiently far from blanket 44, so that the sticked substance cannot cause them any damage.

Although the embodiments described herein mainly address digital printing using a flexible intermediate transfer member, the methods and systems described herein can also be used in other applications, such as in any sort of printing system and process having any suitable type of an intermediate apparatus (e.g., member) for receiving an image and transferring the image to a target substrate.

Moreover, the embodiments described herein are applicable for both simplex and duplex printing systems, such as systems 10 and 11 of FIGS. 1 and 2 above, respectively. In other words, in case one or more embodiments are described for a simplex system such as system 10, these embodiments are also applicable, mutatis mutandis, to a duplex system, such as system 11.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A printing system, comprising:
an intermediate transfer member (ITM), which is configured to receive ink droplets from an ink supply subsystem to form an ink image thereon, and to absorb at least part of an optical radiation directed to the ITM for heating the ITM; and
an optical assembly having one or more sensors, which are facing the ITM, wherein, in response to sensing an optical signal emitted from at least one of the ITM and a substance being carried by the ITM, the optical assembly is configured to produce a signal indicative of the substance.

2. The printing system according to claim 1, and comprising a processor, which is configured to control an operation of the printing system responsively receiving the signal.

3. The printing system according to claim 1, wherein the ITM is configured to transfer the ink image to a target substrate, wherein the substance comprises at least a portion of the target substrate that remains on the ITM after the image has been transferred to the target substrate, and wherein the signal is indicative of the at least portion of the target substrate that remains on the ITM.

4. The printing system according to claim 1, wherein the optical assembly comprises one or more light sources, which are facing the ITM and are configured to direct the optical radiation to a surface of the ITM.

5. The printing system according to claim 4, wherein at least one of the light sources comprises an infrared (IR) light source, the optical radiation comprises one or more IR beams, and the optical signal comprises an IR radiation, and wherein at least one of the sensors is configured to sense the IR radiation emitted from at least one of the ITM and the substance responsively to directing the one or more IR beams.

6. (canceled)

7. The printing system according to claim 5, wherein in response to directing the one or more IR beams: (i) when facing the substance being carried by the ITM, at least a sensor among the sensors is configured to produce a first signal indicative of a first portion of the sensed IR radiation, and (ii) when facing the ITM, the sensor is configured to produce a second signal indicative of a second portion of the sensed IR radiation.

8. The printing system according to claim 7, wherein the optical assembly comprise at least first and second sensing assemblies, which: (i) are mounted on the printing system at first and second locations, respectively, along an axis of the ITM, and (ii) are configured to direct first and second IR beams to first and second positions, respectively, on the surface of the ITM.

9. The printing system according to claim 8, wherein at least part of the first and second IR beams overlap one another.

10. The printing system according to claim 8, wherein at least one of the first and second sensing assemblies comprises the IR light source and the sensor integrated together.

11. The printing system according to claim 7, wherein the ITM is configured to absorb the IR beams, and wherein the second signal is indicative of zero IR radiation emitted from the ITM.

12. (canceled)

13. The printing system according to claim 1, wherein the ITM is moved along a first axis, and the one or more sensors of the optical assembly are arranged along a second axis, different from the first axis.

14. (canceled)

15. The printing system according to claim 13, and comprising at least an impression station, which is configured to transfer the image from the ITM to the target substrate, and wherein the optical assembly is positioned, along the first axis, subsequent to the impression station.

16. (canceled)

17. The printing system according to claim 1, and comprising one or more magnetic sensors, which are facing the ITM and are configured to produce an additional signal in response to sensing an altered magnetism from the ITM.

18. (canceled)

19. The printing system according to claim 1, wherein the substance comprises at least a portion of a first target substrate configured to receive the ink image from the ITM, and comprising a processor, which is configured to receive an additional signal indicative of a second target substrate being introduced into the printing system, and wherein the processor is configured to stop the operation of the printing system when: (i) the signal is indicative of the substance being carried by the ITM, and (ii) the additional signal is indicative of the second target substrate being introduced into the printing system.

20. The printing system according to claim 19, wherein the processor is configured to present an alert when: (i) the signal is indicative of the substance being carried by the ITM, and (ii) no additional target substrate being introduced into the printing system.

21. A method for detecting a substance in a printing system, the method comprising:
positioning an optical assembly having one or more sensors, to face an intermediate transfer member (ITM), which is adapted to be moved and receive ink droplets from an ink supply subsystem to form an ink image thereon, and to absorb at least part of an optical radiation directed to the ITM for heating the ITM; and
sensing an optical signal emitted from at least one of the ITM and the substance being carried by the ITM, and producing a signal indicative of the substance.

22. (canceled)

23. The method according to claim 21, wherein the ITM is configured to transfer the ink image to a target substrate, and wherein the substance comprises at least a portion of the target substrate that remains on the ITM after the image has been transferred to the target substrate, and wherein the signal is indicative of the at least portion of the target substrate that remains on the ITM.

24. The method according to claim 21, and comprising positioning one or more light sources to face the ITM, and directing the optical radiation to a surface of the ITM.

25. The method according to claim 24, wherein at least one of the light sources comprises an infrared (IR) light source, the optical radiation comprises one or more IR beams, and the optical signal comprises an IR radiation, and wherein sensing the optical signal comprises sensing the IR radiation emitted from at least one of the ITM and the substance responsively to directing the one or more IR beams.

26. (canceled)

27. The method according to claim 25, wherein in response to directing the one or more IR beams: (i) when facing the substance being carried by the ITM, producing a first signal indicative of a first portion of the sensed IR radiation, and (ii) when facing the ITM, producing a second signal indicative of a second portion of the sensed IR radiation.

28-39. (canceled)
